(19) United States
(12) Patent Application Publication
(10) Pub. No.: US 2008/0027808 A1
(43) Pub. Date: Jan. 31, 2008

(54) Method For Providing Shopping Advice

(76) Inventor: Saar Wilf, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/782,672

(22) Filed: Jul. 25, 2007

Related U.S. Application Data
(60) Provisional application No. 60/832,894, filed on Jul. 25, 2006.

(51) Int. Cl. G06Q 30/00

(52) U.S. Cl. 705/14

(57) ABSTRACT

A method of providing advice to a shopper, comprising the steps of: receiving a requirement from the shopper; presenting the requirement to an advisor; receiving an identifier of a seller from the advisor; sending the identifier of the seller to the shopper; and receiving a payment from the seller.

### The current application claims the benefit of U.S. Provisional Patent Application No. 60/832,894, filed Jul. 25, 2006, whose disclosure is incorporated herein by reference.

### FIELD AND BACKGROUND OF THE INVENTION

The present invention relates to a method for providing shopping advice to online shoppers.

The Internet has become a popular platform for selling products. Many services (i.e. “Shopping Services”) exist to assist shoppers in making purchase decisions. Purchase decisions can generally be divided into two categories: decisions about where to buy, and decisions about what to buy.

Many Shopping Services assist shoppers in deciding where to buy. One example of such a service is a Price Comparison Service, which provides a comparison of the price of the same product at different sellers. Another example of a service for assisting shoppers to decide where to buy is a Seller Rating Service, which allows shoppers to post feedback on their shopping experience from a seller, for the benefit of other shoppers. Price Comparison Services and Seller Rating Services can be found at www.bizrate.com, www.shopping.com, and www.mysimon.com.

Many Shopping Services assist shoppers in deciding what to buy. One example of such a service is a Product Review Service, which provides articles comparing the performance of similar products and which may also allow shoppers to post feedback on each product. Product Review Services are often provided by the same companies who provide Seller Rating Services. Some examples may also be found at www.pcmag.com and www.pcworld.com. Another example of a service for assisting shoppers in deciding what to buy is Human Customer Service, in which an employee of the seller discusses with the shopper his needs and makes product recommendations. This may be done by live chat (e.g. by using a customer service chat software such as the one provided by www.liveperson.com), by email, by phone, by using a Voice over Internet software (e.g. such as the Skype service available at www.skype.com) etc.

In some cases, Shopping Services receive payments from sellers (“Affiliate Fees”). Payment of Affiliate Fees may be conditioned on a shopper reaching the seller's website following his use of the Shopping Service. Alternatively, Affiliate Fees may be conditioned on a shopper making a purchase from the Seller following his use of the Shopping Service. Alternatively, Affiliate Fees may include a periodic fee. Naturally, many other payment conditions/configurations are possible.

To help identify which Shopping Service sent the shopper to the seller, the seller assigns an Affiliate Identifier to each Shopping Service. The Shopping Service would then place the Affiliate Identifier in URLs that the Shopping Service sends to the shopper's Internet browser. For example, if the URL for a specific product is http://www.seller.com/product, the Shopping Service would present to shoppers the URL http://www.seller.com/product?id=shoppingservice. When the shopper's browser requests this URL (e.g. after the shopper clicks the link for that URL), the seller receives the Affiliate Identifier and knows which Shopping Service should be paid (in this case the one that previously created an Affiliate relationship with the seller and was assigned the Affiliate Identifier “shopping service”). For more information on affiliate marketing see http://en.wikipedia.org/wiki/Affiliate_marketing.

Price Comparison Services and Seller Rating Services are limited in that they do not assist the shopper in deciding what to buy. Product Review Services are limited in that they provide general advice that is not tailored to the needs of a specific shopper. Human Customer Service is limited in that it is operated by a single seller, and therefore it cannot provide unbiased advice.

Many services allow people seeking advice to find relevant advisors and pay them a fee for their advice. Such services may be found at answers.google.com and www.kasamba.com. These services are limited in that they require the party seeking advice to pay.

Many services allow people to post a problem or question, and allow other people to respond. Such services may be found at groups.yahoo.com, groups.google.com, or groups.msn.com. Since these services are free and based on good will, then they are limited in that the responses are often slow and/or unprofessional.

There is an apparent need to provide online shoppers free, unbiased, and professional advice tailored to their specific needs.

### SUMMARY OF THE INVENTION

The present invention is a method for providing shopping advice to online shoppers. According to the teachings of an embodiment of the present invention there is provided a method of providing advice to a shopper comprising the steps of: receiving a requirement from the shopper; presenting the requirement to an advisor: receiving an identifier of a seller from the advisor. Preferably, the step of receiving the payment is contingent upon the shopper performing a transaction with the seller. Typically, performing a transaction includes purchasing a product and/or a service. Most preferably, the identifier of a seller includes an affiliate identifier.

Preferably, further steps include: receiving an identification of at least one product from the advisor; and sending the identification of at least one product to the shopper. Typically, further steps include: receiving information_{[HF1]} about the shopper from the shopper; and presenting to the shopper pricing information of the at least one product based on the information about the shopper. Most typically, the product is a service.

Preferably, further steps include: receiving from a plurality of advisors at least one respective field of expertise; receiving from the shopper at least one field of interest_{[HF2]}; and choosing the advisor from the plurality of advisors based on matching the at least one field of interest and the at least one field of expertise_{[HF3]}. Most preferably, further steps include: presenting respective descriptions of the plurality of advisors to the shopper; and receiving an identifier_{[HF4]} of the advisor from the shopper. Preferably, a further step includes sending a payment to the advisor. Most preferably, the identifier of a seller is at least one chosen from the group including: a website address of the seller; a name of the seller; a phone number of the seller; and an email address of the seller.

### BRIEF DESCRIPTION OF THE DRAWINGS

The invention is herein described, by way of example only, with reference to the accompanying drawings, wherein:

FIG. 1 is a block diagram of a configuration of elements for a method to provide shopping advice to on line shoppers, in accordance with an embodiment of the present invention.

### DESCRIPTION OF PREFERRED EMBODIMENTS

The present invention includes a method for providing shopping advice to online shoppers.

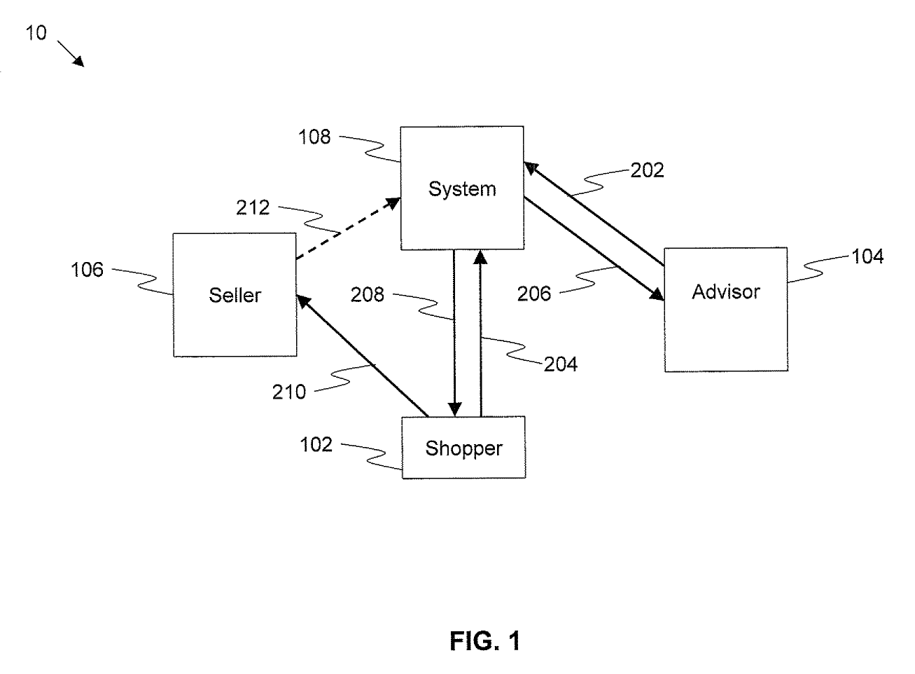

Reference is now made to FIG. 1, which is a block diagram of a configuration of elements 10 for a method to provide shopping advice to on line shoppers, in accordance with an embodiment of the present invention. The configuration of elements 10 comprises: an internet shopper 102; an advisor 104; a seller 106; and a system 108. A method is described hereinbelow to provide shopping advice to shopper 102, based on presenting the shopper's requirements to advisor 104, and then directing the shopper to the appropriate seller or product.

Preferably, the method is carried out using a computer-based system 108 connected to a public network (the “Network”—not shown in the figure). The shoppers and advisors communicate with the system over the network. In one embodiment, system 108 is an Internet website running on a server, and the network is the Internet.

In a typical environment, there are multiple sellers 106 offering products and services to multiple shoppers 102. There are also multiple advisors 104 who have the necessary knowledge and skills to advise the shoppers in making shopping decisions.

One or more advisors 104 communicate with system 108 as indicated by path 202. In path 202, advisor 104 indicates he is available to provide shopping advice. In one embodiment, the advisor also provides to the system descriptions of the advisor's field of expertise (the type of products for which he is qualified to give advice, such as “engagement rings”, “audio systems”, “digital photography”, etc.) which system 108 stores for later use. Communication by path 202 may be performed by an advisor using an Internet browser to access the system's website, and by the advisor then filling a form which includes his field or fields of expertise. Typically, the advisor receives payments from an operator (not indicated in the figure) of system 108. Payments may be a salary, a fee per hour of work, a performance-based fee, etc.

Shopper 102 wishing to use system 108 connects to the system (e.g. by directing his Internet browser to the System's website) by path 204, providing to system 108 one or more requirements. In the specification and the claims which follow, the term “requirement” is meant to relate to a product or service shopper 102 desires. An example of a requirement may be: “I need an audio system for my living room. The living room is 4 meters by 6 meters. I plan to mostly listen to classical music. My budget is 2000 US Dollars.”

System 108 presents one or more requirements to an advisor along path 206. The advisor then provides a recommendation by path 202. The recommendation identifies a seller (or sellers) and/or a product (or products).

The advisor's recommendation is typically helpful in assisting the shopper in finding a product that matches his requirements while minimizing costs to the shopper. Advisor 104 may use his existing knowledge as the basis for his recommendation or he may use external sources such as any of the Shopping Services described hereinabove.

In some cases, before providing his recommendation, advisor 104 may ask shopper 102, by way of system 108, questions that will help the advisor better understand the requirement(s) of shopper 102.

Questions and recommendations may be presented as a URL to a seller's website or to a product's page on that website (not shown in the current figure). Typically, the URL is presented to the shopper as a clickable link on the shopper's Internet browser. Once shopper 102 directs his Internet browser to the URL (e.g. by clicking the link), the shopper starts to communicate directly with seller 106 (i.e. to the seller's website) according to path 210, and the shopper can proceed to purchase the product or service.

Seller 106 recognizes that shopper 102 contacted him following interaction with system 108. This may be done by detecting an Affiliate Identifier, as described previously, placed by system 108 in URLs presented to shopper 102. Alternatively, shopper 102 may directly notify the seller 106 outside of configuration 10 (such as, but not limited to: by placing the name of the system's operator in an HTML form on the seller's website: and by telephone, by saying the seller's name in a voice conversation). Seller 106 pays the operator of system 108 an affiliate fee along path 212.

Communications between shopper 102 and system 108, such as by paths 204 and 208, and/or between system 108 and advisor 104, such as by paths 202 and 206, may be done using any suitable communication method. Possible communication methods include, but are not limited to: live chat; email; HTML forms; Instant Messaging (such as Yahoo! Messenger available at http://messenger.yahoo.com); a telephone conversation; and Voice over Internet (such as the Skype service available at http://www.skype.com).

In one embodiment, advisor 104 is chosen from among several advisors. In this case shopper 102 provides a field of interest (i.e. the category related to the product or service for which he requires advice) for his requirement. The system then connects shopper 102 to the advisor whose field/fields of expertise best match the shopper's field/fields of interest. The choice of the most appropriate advisor may be done by presenting to the shopper all the fields of interest recognized by system 108 (e.g. in a hierarchical directory), and allowing shopper 102 to choose one or more relevant fields. Alternatively or optionally, the choice may be performed by shopper 102 communicating his field of interests to a third party (not shown in the present figure), and the third party manually chooses the appropriate advisor.

In another embodiment, shopper 102 chooses from several advisors 104 based on a description of each advisor's capabilities, experience and/or professional background. Such a description may be provided to system 108 by previous shoppers, or by the operator of the system.

In yet another embodiment, advisor 104 and/or system 108 use information about shopper 106 to find the actual price for different products offered by respective sellers. For example, advisor 104 and/or system 108 may use the location of shopper 102 and/or a profile of shopper 102 to compare shipping costs, tax levels and/or special discounts at different sellers.

In yet another embodiment, advisor 104 and shopper 102 communicate directly, instead of within configuration 10. For example, system 108 may provide to shopper 102 an email address, instant messaging identifier, voice over Internet software identifier and/or phone number of the advisor, and the shopper uses this information to contact the advisor directly.

Because advisors address individual shopper's requirements an advantage of embodiments of the present invention is that shopping advice is tailored to the specific requirements of shopper 102.

Another advantage of embodiments of the present invention is that shopper 102 is directed to products from multiple sellers, thereby increasing the likelihood of reaching an optimal match of the shopper's requirements and at lower prices.

Another advantage of embodiments of the present invention is that since configuration 10 is funded by Affiliate Fees, the service may be free to shopper 102.

It will be appreciated that the above descriptions are intended only to serve as examples, and that many other embodiments are possible within the scope of an embodiment of the present invention as defined in the appended claims.

What is claimed is:

1. A method of providing advice to a shopper comprising the steps of:
a. receiving a requirement from the shopper;
b. presenting the requirement to an advisor;
c. receiving an identifier of a seller from the advisor;
d. sending the identifier of the seller to the shopper; and
e. receiving a payment from the seller.

2. The method of claim 1, wherein the step of receiving the payment is contingent upon the shopper performing a transaction with the seller.

3. The method of claim 2, wherein performing a transaction includes purchasing a product.

4. The method of claim 2, wherein performing a transaction includes purchasing a service.

5. The method of claim 1, wherein the identifier of a seller includes an affiliate identifier.

6. The method of claim 1, further including the steps of:
a. receiving an identification of at least one product from the advisor; and
b. sending the identification of at least one product to the shopper.

7. The method of claim 6, further including the steps of:
a. receiving information_{[HF6]} about the shopper from the shopper; and
b. presenting to the shopper pricing information of the at least one product based on the information about the shopper.

8. The method of claim 7, wherein the product is a service.

9. The method of claim 1, further including the steps of:
a. receiving from a plurality of advisors at least one respective field of expertise_{[HF7]};
b. receiving from the shopper at least one field of interest_{[HF8]}; and
c. choosing the advisor from the plurality of advisors based on matching the at least one field of interest and the at least one field of expertise_{[HF9]}.

10. The method of claim 1, further including the steps of:
a. presenting respective descriptions of the plurality of advisors to the shopper; and
b. receiving an identifier_{[HF10]} of the advisor from the shopper.

11. The method of claim 1, further including the step of sending a payment to the advisor.

12. The method of claim 1, wherein the identifier_{[HF11]} of a seller is at least one chosen from the group including:
a. a website address of the seller;
b. a name of the seller;
c. a phone number of the seller; and
d. an email address of the seller.
